(19) United States
(12) Patent Application Publication
(10) Pub. No.: US 2010/0293054 A1
(43) Pub. Date: Nov. 18, 2010

(54) Method of Customizing Webpages for Content/Advertising by Using Cost per Action Fees and Rebates

(76) Inventor: Steven H. Lieberman, Washington, DC (US)

Correspondence Address: GREENBERG & LIEBERMAN, LLC, 2141 WISCONSIN AVE, N.W., SUITE C-2, WASHINGTON, DC, 20007, US

(21) Appl. No.: 12/734,462

(22) PCT Filed: Feb. 22, 2007
(86) PCT No.: PCT/US07/62591

§ 371 Date: Aug. 22, 2008

Related U.S. Application Data
(60) Provisional application No. 60/766,959, filed on Feb. 22, 2006.

(51) Int. Cl. G06Q 30/00

(52) U.S. Cl. 705/14.54; 705/14.69; 705/14.71

(57) ABSTRACT

A method for advertisers to promote their services or products on the Internet using a cost-per-action fee with a low to zero pay-per-click fee. A business method provides for an online search advertising company that dynamically customizes webpages for content and advertising based on searches performed by users and other important criteria. Advertisers can opt-in to an automated rebate system that automatically pays them and the user back for sales made through the system.

### FIELD OF THE INVENTION

The present invention is an improved method for advertisers to promote their services or products on the Internet.

### BACKGROUND OF THE INVENTION

The art of online searching using search engines and advertising on the Internet, as well as monetization of click-throughs based on pay-per-click fees, and cost-per-action fees on webpages is known. Online search engines and online advertising have skyrocketed in recent years to encompass a variety of methods.

Built on the most successful search engine technology in the world, Google, Yahoo & MSN allow advertisers to place text ads whenever a user searches a keyword the advertiser has chosen to trigger his advertisements. The cost of keywords is based on a bidding system, where the highest bid receives the best space. With 250 million unique searches per day, Google commands worldwide dominance in this market. Ninety percent of all Google revenue comes from advertising dollars.

Although Yahoo started far earlier than Google, it concentrated on developing its Portal content network, selling ad space as any newspaper might. Recently, through the purchase of Overture, Yahoo has entered the search engine market with a focus on taking over high priced, generic term search advertising. It is steadily gaining ground on Google in the US market. This has been accomplished by mining the good relationships Overture had with corporate America. By and large, Yahoo can still command the top US advertisers, where Google has had its least success. MSN is considered a first tier player because of its financial might, but it is a latecomer to the game and its search engine technology is considered quite poor.

Second and third tier players include Roar, FindWhat, Kanoodle, and others. They have tried with the same level of success to break the hold of the big two on the market. They provide a second-rate interface, sloppy signups, and relatively small traffic networks. These companies lack management focus, resources, business differentiation and brand awareness. They do not have the search engine technology Google possesses or the network of advertising muscle Yahoo flexes.

A9 Search Engine (Amazon) and AdBrite are showing a much better understanding of the market. First, they are establishing solid business relationships and attacking market segments found unfavorable by the big two, namely, what is referred to as ‘Vice-Clicks.’ In a way, AdBrite is cleaning up the Internet porn market, while A9 has the backing of Amazon and Alexa (an online tool used to rate the traffic and reach of all webpages that is virtually the cornerstone of any savvy internet user looking for detailed information on a website).

Google and Yahoo are looking to solidify their place in the market by leveraging better technology and superior industry contacts to drive out secondary players. However, with strategic planning and resources, it seems self evident that a company can begin to gain ground in a market barely five years into existence. It is also important to note that these companies have chosen to sell Search Advertising as a purely Pay Per Click (PPC) service. They have build out separate networks for storefronts and sales. However, there is no integration of these two services.

Some search engines outsource their search advertising to third parties; AOL, for example, uses Google. There are essentially two players in the current market—Google and Yahoo. The Internet, with hundreds of millions of searches and views daily, has essentially Google and Yahoo as the two agents with sophisticated search marketing technology. It is also important to note that Microsoft has launched its own search-marketing engine, but Microsoft is still three generations away from providing a viable competitor to the two larger search networks.

Engines and parties that pertain to domains and syndicate advertising are the following:

Domain Sponsor—The leader in worldwide domain ‘parking’ services. It syndicates Google advertising as well as integrates separate networks (mostly self owned) into its feed. They generate advertising links based on user keywords. These keywords are generally based on the domain name, i.e. browntrucks.com would be optimized for ‘Trucks’ and would return appropriate advertising from Google. They record hundreds of millions of unique visits per month.

Fabulous.com—This Australian company is publicly traded and represents a common type of traffic maker. It owns an estimated 300,000 domains AND offers a domain-parking network to the public that is also a non-exclusive syndicate of Google. They are the undisputed kings of the ‘vice-click,’ specifically having the most elaborate online casino PPC (Pay-per-click) network.

NameDrive.com—a smaller, second wave company that nonetheless represents Google's fastest growing 3^{rd} party distributor, and is coincidentally owned by two of the present invention's partners. It has grown from $400 per day to $20,000 in five months. Out of a network of hundreds of syndicated resellers, ND has managed to grow into a top ten player with a relentless pursuit of innovative technical applications and superior customer support.

Domain Owners—companies and individuals who control from 10,000 to 1 million domains or from 100,000 to 100 million unique views per month. Many of them are direct with either Google or Yahoo. These companies include NameAdmin and Tidewinds. Ads can also be distributed into I-frames on existing webpages.

While PPC advertising has shown tremendous potential, the chinks in the armor are beginning to show. Click fraud is robbing the industry of million of dollars per month; as more advertisers enter the market, they are forced to pay increasingly higher rates per click for decreasing returns; the lack of advertising customization drops the branding potential of each text ad. The CPC market is currently generating less than $7 billion yearly even though Internet usage has surpassed Television as the number one leisure activity in America. Dollars will continue to flow to the Internet, but where?

With the advent of keyword-based search marketing, large ad placement firms who formerly found themselves purchasing print and television space quickly regrouped, and entered the search marketing industry by purchasing keywords. These ad services purchase millions of dollars in keyword terms every day.

Revenue for online advertising is initially taken from the following sources:

Pay-per-click (PPC)—Advertising partners are charged a flat $.10 cent fee for each advertisement that is clicked by an end user.

Cost per Action (CPA)—Each advertiser bids for the amount of money they are willing to pay for a desired action by the users. This bid also determines their position on displayed advertising results. The highest bid leads to the most desired position.

There is a need for a way of dynamically customizing webpages for content and advertising based on searches performed by users and additional criteria.

There is a need to advance the search engine market even further. As aforementioned, search adverstising sold as PPC and/or CPA generates money, but the business model is not growing as fast as the use of the Internet. This means that the business model is not ideally matched for the needs of those who want to advertise on the Internet. There is a need for a method for advertising on the Internet that takes the PPC and CPA models a step closer to that which would be more palatable to the Internet advertiser. Quite simply, there is a need for a search engine that can sell advertising space based on CPA with a low PPC fee. CPA is more associated with generating money than PPC, however, PPC still represents a daunting payment for the Internet advertiser. How to make such a system work is the problem.

### SUMMARY OF THE INVENTION

The present invention is the world's first large-scale CPA search engine that combines rebates on products and services with other features such as video feed, basic relevant information about the keyword, and sponsored links. It is an online search advertising company that dynamically customizes webpages for content and advertising based on searches performed by users and other important criteria. The content displayed on the pages originates from public sources, while the advertising is directly procured by the present invention. The present invention can draw from an existing and accessible pool of over 30 million unique visitors per month to start.

Savings Performance—When a user purchases a product made through a click on an ad, the rebate selected by the advertiser (typically from 5 to 30%) is automatically deducted from the bid price of the advertiser and credited back to the advertiser for bids. In this way, the user benefits from the signup rebate and the advertiser profits from the sale.

First, it is an object of the present invention to eliminate click fraud. Search advertising ads are generated based on search terms entered by the user or via content mapping. Many of these advertisements are abused and clicked by competitors, domain owners and Robotic clicking software. It is estimated as much as 30% of all clicks are fraudulent. The present invention charges a nominal 10-cent fee per click (clicks on Google and Yahoo average out to more than a dollar; however, the most desired keywords can reach between $10-50 dollars per click) and instead concentrates on charging significantly higher rates for delivering purchases or quality leads to the advertiser (CPA fees). While this does not eliminate potential fake clicks, it removes incentive to click.

Second, it is an object of the present invention to centralize the CPA market. Currently, the CPA market is fragmented into affiliate networks that concentrate on niche advertising, such as video game sales or credit card sign ups. Affiliate networks created the cost per action concept. They aggregated companies that had little or no knowledge of the Internet and offered to sell products and develop sales channels for a percentage of the sale. These networks are not focused around a search technology. They market through their clients, namely companies or individuals who manage Internet traffic. There is no de-facto leader, although the Commission Junction in the US and Trade Doubler in Europe seem to have a hold on the top brands. They lack the search technology and pull to centralize their buying and affiliate sellers. While these companies compete for the same advertising dollars as the present invention, it is expected that these companies will be some of the biggest users of the present invention, as they can instantly integrate their elaborate sales networks into the search technology of the present invention.

Third, the present invention is able to accommodate most keyword searches, which leads to a centralized market for CPA advertising and helps consolidate much of the fragmented affiliate network industry.

Fourth, the present invention has effective search engine optimization (SEO) strategies. SEO strategies deliver far better returns to advertisers than search advertising; users trust web results more than sponsored results. Currently, neither Yahoo nor Google allow domain owners to introduce SEO methods for ratcheting domains up the search indexes.

Finally, it is an object of the present invention to track user keyword information, incoming IP and other information to pinpoint the user's interests. This triggers incoming XML and RSS (Resource Description Framework Site Summary) feeds to deliver topical content. This also triggers the desired advertisements. With a constant refreshing of content and other SEO ‘tricks,’ the present invention significantly increases the standing of advertisements on all major search engines.

Advertisers understand keyword marketing. They know, for example, that if ten people type the words ‘brown truck’ into Google or Yahoo, one of them will click their text advertisement. They know that, for example, if ten of these people arrive on their page from clicking, they will sell one of their products. These are fictional examples, but they characterize roughly how an advertiser or advertising buyer operates. They set budgets based on anticipated views and clicks on their text links, and then tweak their campaigns based on new products, geographical region, season, etc. The present invention takes this standard format, but asks the advertiser to bid on the amount they are willing to pay for a sale or user action and not a click (all clicks are standardized at $.10 cents). The advertiser places his bid on relevant keywords, and when his text/image Ad is clicked by the user, he pays the small fee. If that user continues and purchases a product or completes the desired action, the advertiser pays his bid on the keyword. This has significant advantages over the current CPC model:

CPA ensures that the advertiser only pays at the point of sale and not before, eliminating click fraud and untargeted user queries. It eliminates the CPC keyword auction. Advertisers are forced to pay increasingly higher click prices on traffic that has no guaranteed quality filter. Anticipated savings from the CPA model may reduce the cost of selling on the Internet 5 fold. CPA works far better than PPC on premium, heavily trafficked domains. By accruing a large stable of premium names, the present invention can associate itself with only the finest names on the Internet.

The auction on keywords will work on the bidding system with highest bids receiving premium page location. This system keeps CPC prices stable, while encouraging advertisers to bid on actual sales prices. The components for building a successful CPA platform—Topical Advertising, Premium Ad Server Technology, and Quality Traffic Aggregator—can be found within the present invention.

Topical Advertising—Internet products with built-out online networks work best to start: legal, music downloads; software downloads; Internet services; and Cost per Lead services, such as real estate leads and mutual fund/stock market mailers. Currently, the present invention manages millions of dollars in these types of advertising accounts.

Ad Serving Technology—Over the course of the last year, the present invention has been working closely as a premium syndicate of Google advertising. In that time, the present invention has tracked all incoming information to its domains. The present invention therefore has the historical data to mount an incredibly sophisticated Ad publishing and syndicating platform. In addition, the present invention manages online campaigns that buy hundreds of thousands of dollars in keywords on search engines every month, giving a detailed picture of keyword performance and CPA conversions.

Traffic Aggregator—Traffic, not cash, is king on the Internet. The Internet bust has taught many valuable lessons; foremost is that without significant Internet traffic, funding, business connections, and brilliance of concept are largely a waste of time. The present invention, through its partners, manages roughly 30 Million hits per month and is growing from between 50 to 100 percent per month. The present invention is also able to manage upwards of 60,000 domains on which to display custom results. Why work with individual domain owners, when a user can work with networks that manage 1 million domains? The present invention's alliance with Name Drive allows all such traffic aggregators to direct traffic to the present invention's advertisers in an already known and easy format.

### BRIEF DESCRIPTION OF THE ACCOMPANYING DRAWINGS

FIG. 1 is a technical overview of the present invention.

FIG. 2 is an example of the present invention as used on an actual webpage.

FIG. 3 is a flowchart explaining the process of posting an advertisement/rebate and a sale.

### DETAILED DESCRIPTION OF THE PREFERRED EMBODIMENT

The present invention is unique in several primary ways: first, there is a low (to nonexistent) PPC fee; second, every advertiser will provide a rebate to a user in an automated fashion; third, relevant information to the user's query (keyword) will appear on the search results, in addition to advertisers and services; and last, it is the largest CPA search engine. The present invention compiles links to websites that are only looking to make a sale, making searching for and purchasing a product on the Internet much more efficient for a user. The combination of these various factors makes the present invention an improvement on any prior art.

The specific elements of the present invention are:

CPA and PPC text/image ads.

At least one sponsoring banner advertisement.

A cost per action box, where the user can enter his email address for information.

Sponsored software downloads.

Wikipedia and public RSS Information presented on the webpage in some relevant form. The present invention would mix XML and RSS feeds so that the content would look more informational and less “gimmicky.”

Video/text blog feeds.

Cross-referential product recommendations based on historic searches.

Syndicated ads showing the title, ad content, ad URL, and the rebate level on the click.

On left side of panel, ads for products, services, and locations of stores to find products/services.

The possibility of modifying the search with source listing, implementing related keywords to the user's search near the search box.

Additional aspects of the present invention include:

Free shopping cart which accepts java script of user ID and item amount, allowing anyone that is selling stuff to have a simple database (like Excel or Open Office on their machine, and use a web interface for it to be dropped directly into a cart). This saves the user money and is beneficial for the present invention as there is payment everytime someone buys something (1-2% is added on if the user uses present invention's shopping cart).

Single place affiliate signup so domainers can include affiliate advertising as a portfolio item.

affiliate, key word and pay rating list. Domainers putting resources and domains into the engine should be able to see what pays the most and the least based on history, and be able to allocate where they put their resources easily, just like the stock market.

Advertisers' statistics list, showing advertisers' key words, click-through rates, buy rates and any other statistical data available (age range when the user allows that information to be shared, likes, dislikes, etc.).

online video game advertising.

dual column left side advertising, right side information from wikipedia.

email search.

radio buttons with distance and price ordering.

wap (wireless application protocol) view.

wap view that uses the locator button to search for a store selling the item needed, listing stores based on the person's current location (automatically if locator feature is on and asking for an address or other info if not).

java search view (including drag and drop to save bar, etc.).

history button (search history within database of present invention).

Auto search where a user puts in a detailed search list of what they want, the system does the search on a regular basis, then emails the search results to the user. The user can choose to only get results if a certain thing happens (for example, there is a price drop or sale on an item). The user can also log in whenever and access the searches. This capability can eventually be extended to search all of the Internet search engines with Boolean search capabilities.

search bar with peer to peer interface so all users save data (if they want) can be saved on their home machine only for security purposes and to provide other capabilities.

option to auto-delete searches and history for security purposes.

product price history.

The combination of all these various elements make the present invention a unique improvement on any other search and advertising engine on the Internet.

The present invention will prepare pre-designed user interfaces for different industry categories. The present invention would act as the fulfillment agent and customer care point. This will allow developers to go from finished product to professional sales point in a matter of hours.

The greatest challenge for the present invention will be to acquire targeted traffic. Without targeted traffic views do not get displayed, users will not click and sales will not be closed. Therefore, an incentive for acquiring traffic is offering a rebate on services and products as determined by the advertiser.

A test sample of quality traffic will be needed to satisfy initial advertising. The present invention, through its partners, can deliver 30 million unique visits to start. Second, quality URL type in traffic is currently looking for alternative to Google and Overture. Both firms have recognized their virtual monopoly on the PPC market and are currently squeezing both domain owners and domain aggregators. By offering these firms nonexclusive and competitive terms, the present invention can generate millions of views from one client.

The current trend or desire by premium domain owners is to provide users a trusted experience on their webpages that integrates relevant information, entertainment and human interest content, and multiple levels of targeted advertising. The present invention delivers on all these fronts, in essence building a hybrid Google and Yahoo results and homepage completely for hundreds of thousands of domains.

Rather than being forced to attract advertisers individually, as Google has been forced to, the present invention can go directly to large brokers and begin preliminary testing on the present invention to buy product as they will understand (1) that they have a better chance on a discount on the product through the present invention than anywhere else and (2) the present invention direct search, unlike Google or Yahoo, provides links ONLY to entities which wish to make a sale, eliminating the endless search for a product.

The present invention would be one of the first professional and centralized search marketing CPA solutions on the Internet, beating both Google and Yahoo to market. The added element of SEO on each page should make the present invention very popular on the Google and Yahoo search engines.

While Yahoo cannot syndicate Google advertising and vice-versa, there is no inherent obstacle to preclude domain aggregators from using the present invention as their CPA network.

The present invention will build pages that Google and Yahoo search engines recognize as good for users. The open Google network and closed Yahoo network are used to market and advertise. A user is ten times more likely to check web results before clicking advertising results. The present invention will be the agent by which less savvy advertisers ratchet their products and services up the search engines.

While Google has done well to market itself to AOL and LookSmart as the PPC of choice, the present invention will do the same as the CPA of choice. The present invention has a well-established link to domain aggregators and owners that will jump at the chance to incorporate the present invention's feed into their pages, as most of them lack a sophisticated CPA agent.

The present invention will use, licensed from one of its partners (Name Drive), a sophisticated optimization software that breaks domains down and optimizes for content, advertising, and images on the fly.

For example, assume a user is surfing the net for small business loans for his pizza restaurant and finally decides to type in the term Pizza into his browser. Under normal search engine technology, Google and Yahoo would display Pizza links on the page. Not so with the present invention; it would automatically scan the content and links from the page the user is coming from, his IP address and deliver advertisements for small business loans, relevant content for this theme, investment advice, etc. If the user typed this search directly into the Google or Yahoo search engine, it is likely that one of thousands of SEO'd domains or the the present invention homepage itself would be on the front page, and would take the Google search term and optimize the search accordingly. This occurs for ALL INCOMING searches referred from Google or Yahoo to either the present invention's partner domains or the homepage itself

The following gives an outline of how the present invention works and the service is sold:

There may be a placement of ads in text and image form also offering pop-under ads. The service is search-based and contextual (“keyword”), cross-referenced to enable advertisers to more effectively reach their targets. The flat-lined cost-per-click is $0.10. In addition, there is comprehensive real-time backend reporting; automated campaign management; and easy to understand self-publishing and registration interface.

The present invention enables advertisers to state what they are willing to pay in terms of a sale or lead conversion. The present invention also reduces issues of click fraud, which is growing rapidly. Since it is a CPA system, it is unlikely that someone would fraudulently buy a product on a site.

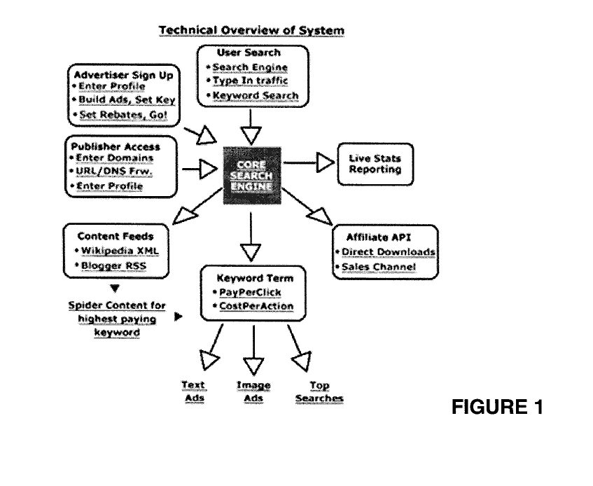

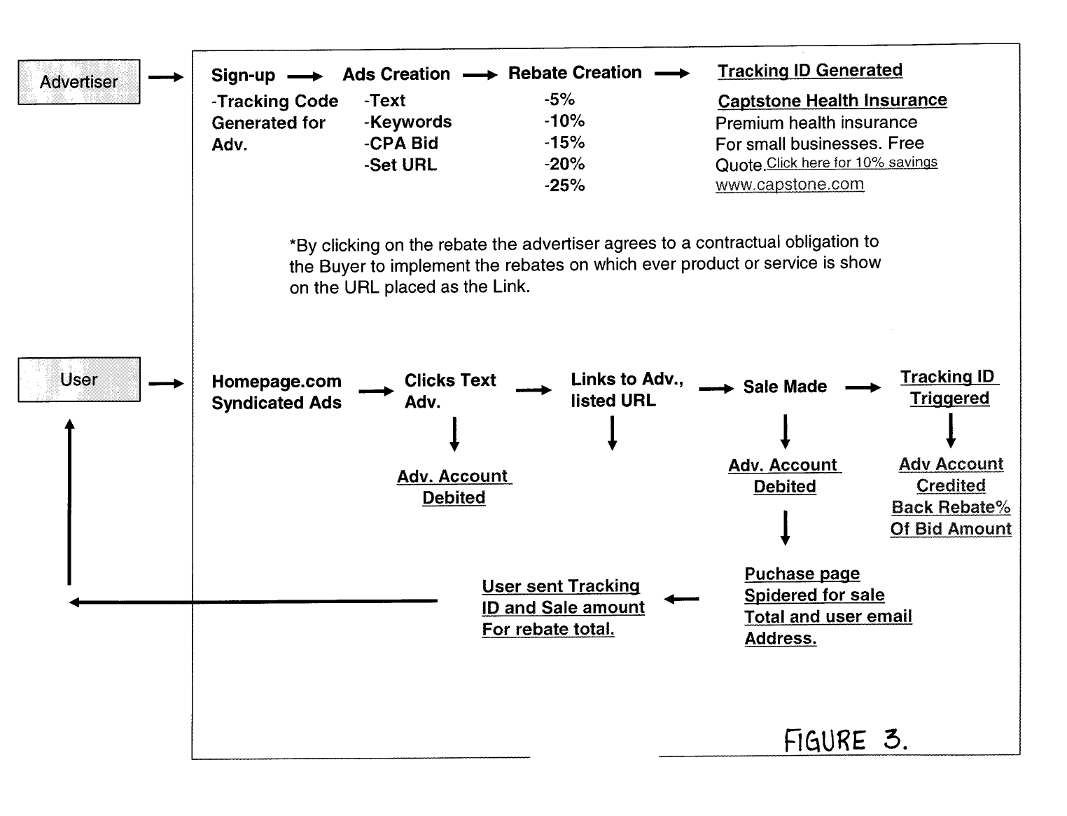

As shown in FIGS. 1 and 3, both advertisers and publishers can use the present invention. For advertisers, a standard interface allows them to:

Set profile

Build text ads

Bid on keywords

Set rebates per keyword

A special tracking ID will be created for each campaign created with a rebate. This tracking ID will follow the click and will automatically deduct the percentage and put it back in the advertisers budget. The advertiser will have to upload image ads and API (Application Programming Interface) for affiliates to add keywords, products, and services to the site without standard access to their account.

For publishers, they can submit domains for parking via URL or DNS (Domain Name Server) change or they can publish advertising directly to their pages via I-frames. They can also:

Set Profile

Choose auto optimization or self optimized keyword.

Set Service

Parked Domain—XML Feed

I-Frame—sent via XML or HTML feed.

The search is broken down into two key modules:

Search Algorithm—this takes strings of words in a standard search and retrieves relevant keywords for advertising. It also retrieves cross-referenced affiliate downloads, products, services and content.

Content/Domain Optimization—This system retrieves domain names, referrals and spiders content to serve ads to syndicate domains, popunders, banners and text ads to partner sites.

The present invention syndicates ad forms in three manners.

1. Text Ads—the advertiser builds these directly. The advertiser is required to cut and paste a simple HTML line of code into their webpage to allow us to track click through to verify sale or completion of action.

2. Image Ads—works on same premise as text ad. Image ads can be used as popunders and banners inserted into content relevant pages.

3. Top Searches—these are direct sales or download points used by affiliates.

4.

Affiliates can place advertising on the page for direct downloads, sales, and special campaigns. Referring to FIG. 3, for each campaign, an ID will automatically be created for the advertisers. Advertisers can pay via: Credit card, Paypal, or Direct deposit. Marketing partners and affiliates are paid via: Paypal, BillPay or Wire Transfer.

The technical model implemented by the present invention is a combination of PPC and CPA advertising. It requires direct contact/billing with advertisers, affiliate integration, and dynamic content feeds. The system is simple enough for first-time users to access and implement with little difficulty.

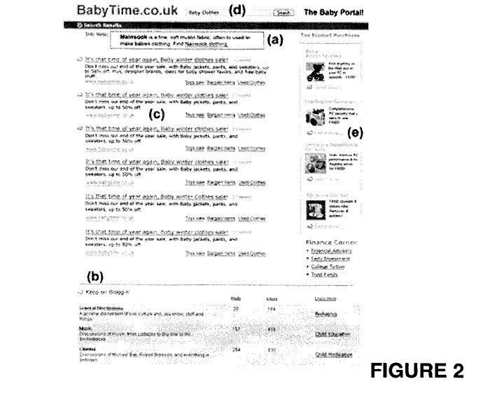

The content and results on the page have two primary functions: to increase the page's popularity on available search platforms, such as Google, and to get the user to click the advertisements. As shown in FIG. 2, which is a webpage, (A) is the informative text—a brief explanation of relevant content. This is achieved by interpreting incoming referral and link information. This text will not be clickable but will generate a relevant link. XML or RSS feed insures the content is both dynamic and relevant. (B) is brief blog/news links with descriptions will be available. These will be paid links. Then, (c) is detailed text advertising, displayed as web searches. These are also paid links that lead to the client's sites. (D) is a search box for extended user searches. (E) is affiliate/top search image and text.

To conclude, the present invention will be the world's first Cost Per Action Search Engine that effectively combines rebates as an incentive for traffic and other relevant information directly on the webpage.

1. A method for promoting services and products on the Internet, comprising:
Using a cost-per-action fee;
Using a low to zero pay-per-click fee;
Dynamically customizing webpages for content and advertising;
Basing said customization of webpages on searches performed by users and other important criteria; and
Advertisers opting in to an automated rebate system.

2. A method for promoting services and products on the Internet, comprising:
Using a cost-per-action fee;
Using a pay-per-click fee; and
Providing webpages for content or advertising or any other content,

3. A method of customizing webpages, comprising:
providing a webpage with links from advertisers;
charging the advertisers a nominal fee per click of each of the links;
charging the advertisers a fee per action of a user;
providing an automated rebate to the user per the action of the user.

4. The method of claim 3, further comprising allowing advertisers to bid on the fee per action.

5. The method of claim 4, further comprising placing the links from advertisers on the webpage according to an amount that each of the advertisers bids on the fee per action.

6. The method of claim 3, wherein the automated rebate is provided by the advertiser.

7. The method of claim 3, further comprising providing a window in which to type a query.

8. The method of claim 7, further comprising providing relevant information in response to the query, the relevant information different than the links from the advertisers.

9. The method of claim 8, further comprising providing cost per action and pay per click advertising in response to the query.

10. The method of claim 3, wherein the action of the user is the user entering the user's email address.

11. The method of claim 10, further comprising providing information to the user, via the user's email address.

12. The method of claim 3, wherein the action of the user is the user downloading software.

13. The method of claim 8, wherein the relevant information is XML and RSS feeds.

14. The method of claim 8, wherein the relevant information is video.

15. The method of claim 8, wherein the relevant information is text.

16. The method of claim 8, wherein the relevant information is a blog feed.

17. The method of claim 3, further comprising displaying the automated rebate prior to the user clicking on any of the links.

18. The method of claim 3, further comprising providing a shopping cart that services the advertisers.

19. The method of claim 3, wherein the advertisers are only entities which wish to make a sale.

20. The method of claim 3, further comprising:
allowing advertisers to bid on the fee per action;
placing the links from advertisers on the webpage according to an amount that each of the advertisers bids on the fee per action;
wherein the automated rebate is provided by the advertiser;
providing a window in which to type a query;
providing relevant information in response to the query, the relevant information different than the links from the advertisers;
providing cost per action and pay per click advertising in response to the query;
wherein the action of the user is the user entering the user's email address;
providing information to the user, via the user's email address;
wherein the action of the user is the user downloading software;
wherein the relevant information is XML and RSS feeds;
wherein the relevant information is video;
wherein the relevant information is text;
wherein the relevant information is a blog feed;
displaying the automated rebate prior to the user clicking on any of the links;
providing a shopping cart that services the advertisers; and
wherein the advertisers are only entities which wish to make a sale.
